(19) United States
(12) Patent Application Publication
(10) Pub. No.: US 2006/0279783 A1
(43) Pub. Date: Dec. 14, 2006

(54) Apparatus and method for determining and setting finishing parameters for a document being printed

(75) Inventor: Hiroyuki Kato, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/147,454

(22) Filed: Jun. 8, 2005

(51) Int. Cl. G06K 15/00

(52) U.S. Cl. 358/1.18; 358/1.12

(57) ABSTRACT

An apparatus and method for determining finishing parameters for a document having one or more pages includes performing a layout analysis that determines a location and type of at least one object for each page of the document. At least one rule is applied to results of the layout analysis, and at least one available finishing parameter is determined for the document based on applying the at least one rule to the results of the layout analysis.

### FIELD OF THE INVENTION

The present invention relates generally to image processing and, more particularly, to a system and method for determining and setting finishing parameters for a document being printed.

### BACKGROUND OF THE INVENTION

In some image forming devices, which can be a printer, a copier, or a multi-function peripheral or printer (MFP), it is possible for the document being printed or reproduced to have finishing settings or parameters. The finishing parameters include, for example, stapling, hole punches, image shifts, and page numbering. Unless the finishing parameters are included with a stored document, such as a document stored in the box of an MFP, the user needs to set the finishing settings manually. The box of the MFP is a non-volatile memory, such as a hard disk drive, that stores documents and files in the MFP.

When a stored document does not include any finishing settings, it is possible to use an orientation detection analysis to determine the finishing settings of the document when stored. In such systems, however, it has not been possible to provide an ability to edit the stored document. As a result, the finishing setting cannot be determined by the performance of the orientation detection analysis on the edited document.

### SUMMARY OF THE INVENTION

According to an aspect of the invention, an image forming apparatus and method for determining finishing parameters for a document having one or more pages includes performing a layout analysis that determines a location and type of at least one object for each page of the document. At least one rule is applied to results of the layout analysis, and at least one available finishing parameter is determined for the document based on applying the at least one rule to the results of the layout analysis.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a computer network consistent with the present invention.

FIG. 2 is a block diagram of an MFP and its related functions consistent with the present invention.

FIG. 3 is a block diagram of a finishing parameter detection system consistent with the present invention.

FIG. 4 is a flow diagram of a process for detecting available finishing parameters of a document consistent with the present invention.

FIG. 5 is a flow diagram of an image shifting process consistent with the present invention.

FIG. 6 is a graphical representation of an image shift consistent with the present invention.

### DETAILED DESCRIPTION OF PREFERRED EMBODIMENTS

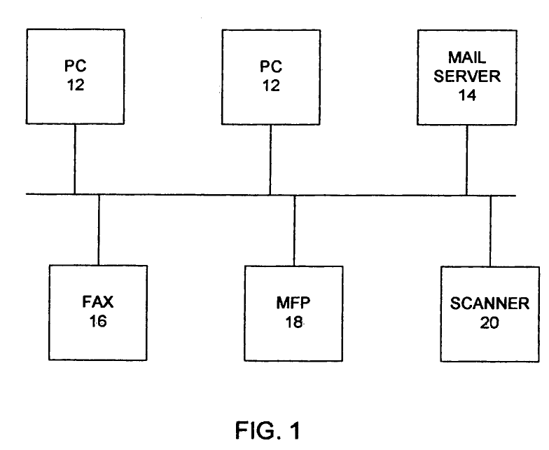

FIG. 1 is a block diagram of a computer network consistent with the present invention. As shown in FIG. 1, the computer network includes a pair of personal computers (PCs) 12, a mail server 14, a fax 16, an MFP 18, and a scanner 20. Each of these components may be coupled together by a network connection or by a direct communication connection. The network connection may be implemented by a local network, such as a LAN, or a public network, such as the Internet.

The PCs 12 may be a workstation, desktop or laptop computer, a mobile phone, a PDA, a magnetic card, or some combination thereof, or any other computing structure. Each PC 12 preferably includes a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for each PC 12 provides a two-way data communication coupling, such as to a network. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information.

If the network connection is an Internet connection, the PCs 12 can transmit a requested code for an application program through the Internet, an ISP, the local network and the communication interface. The received code can be executed by the CPU in the PCs 12 as it is received, stored in the storage device, or stored in some other non-volatile storage for later execution. In this manner, the PCs 12 may obtain application code in the form of a carrier wave.

Like the PCs 12, the mail server 14 preferably includes a CPU, a main memory, a ROM, a storage device and a communication interface all coupled together via a bus. The mail server 14 is configured to enable the PCs 12 to create e-mail messages. The mail server 14 is also configured to handle the sending and receiving of e-mail messages, as well as storing e-mail messages.

As shown in FIG. 1, the PCs 12, the mail server 14, the fax 16, the MFP 18, and the scanner 20 can all be part of the same local network. As part of the same local network, a firewall can provide protection to these devices in the local network from unauthorized access. It is also possible for each of these devices to be independent of a local network, with access provided through the Internet.

The fax 16 is a device that is capable of sending or receiving a fax job. The received fax can be printed by the fax 16 onto a paper sheet. Alternatively, the image data of the received fax can be stored by the fax 16 in an image file. The format of the image file can be set automatically by the fax 16 or changed to a preferred format for a user.

The MFP 18 is a device that is capable of performing a plurality of functions, such as printing, copying, faxing, scanning and acting as a file server. The MFP 18 typically includes at least two of these functions. In its capacity as a file server, the MFP 18 can include a box, which serves as a storage area for files and documents that are accessible to the devices coupled to the computer network. Furthermore, the box of the MFP 18 is configured to receive and store files and documents received from the devices coupled to the computer network, such as fax files from the fax 16, scanned files from the scanner 20 or e-mails from the mail server 14 or the PCs 12.

The scanner 20 is a device that is capable of generating an image data file from an original document. The scanner 20 scans original images from documents placed on a document table, which is typically a glass plate. The scanner 20 includes a light source, such as a lamp, that scans light across the document. The light reflected by the document is directed to a light detecting sensor, which converts the detected light into digital image data. The light detecting sensor can be implemented as a charge-coupled device (CCD). The detected digital image data can be stored by the scanner 20 in an image file, and the scanner 20 can transfer the image file to the MFP 18 for storage in the box.

Although FIG. 1 shows only one fax 16, one MFP 18, and one scanner 20, the computer network may be coupled to just one of these types of devices or may have a plurality of one or more of these types of devices or any other type of device that may be connected to a network. Further, since the MFP 18 is capable of handling the faxing and scanning functions of the fax 16 and the scanner 20, respectively, the MFP 18 can be considered as including the fax 16 and the scanner 20 in a single device.

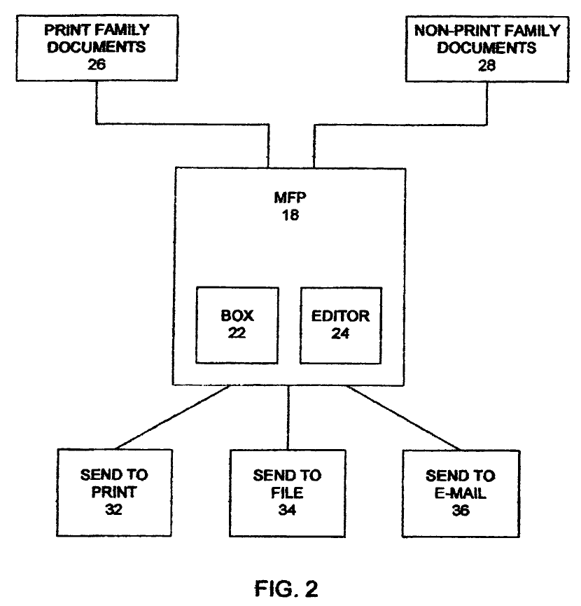

FIG. 2 is a block diagram of an MFP and its related functions consistent with the present invention. As shown in FIG. 2, the MFP 18 is capable of receiving print family documents 26 and non-print family documents 28. Further, the MFP includes a box 22 and an editor 24. The MFP also includes the capability of processing the received print family documents 26 and the non-print family documents 28 by performing functions including a send to print 32, a send to file 34, or a send to e-mail 36.

In general, the distinction between print family documents 26 and non-print family documents 28 is that print family documents 26 received by the MFP 18 can include finishing parameters whereas non-print family documents 28 received by the MFP 18 do not include finishing parameters. As described above, finishing parameters are settings used to reproduce a document and may include, for example, stapling, hole punches, image shifts, and page numbering. Unless the finishing parameters are included with a stored document, such as a document stored in the box of an MFP, the user needs to set the finishing settings manually.

Examples of print family documents 26 include copy documents (i.e., documents being copied by the MFP 18) and documents provided from the network for printing, such as word processing documents submitted for printing by a word processing application operating on a PC 12. The print family documents 26 received by the MFP 18 may include finishing parameters, though they do not have to include them. If the received print family document 26 is stored in the box 22, then it is stored with its finishing parameters, if any. Examples of non-print family documents 28 include scanned documents such as documents scanned by the scanner 20, faxes such as received by the fax 16, and e-mail such as received from the mail server 14 or the PCs 12. Since the non-print family documents 28 do not have finishing parameters, no finishing parameters are stored with a non-print family document 26 stored in the box 22.

The box 22, as described above, is a non-volatile memory, such as a hard disk drive, that stores documents and files in the MFP 18. The documents and files stored in the box 22 can include the fax files from the fax 16, the scanned files from the scanner 20, and e-mails from the mail server 14 and the PCs 12.

The editor 24 is configured to enable a user to view, edit, change, and save files and documents stored in the box 22 of the MFP 18. The editing functions provided by the editor 24 include, for example, merging pages of two or more documents, viewing all documents or pages as thumbnail images, viewing all documents or pages in a list, and cutting, copying, pasting, or deleting a document or page. To use the editor 24 to edit a document or file stored in the box 22, a user at one of the PCs 12 can access documents stored in the box 22 via the network and edit the accessed documents using the editing functions available on the editor 24. After finishing the editing of the document, the user saves the edited document in the box 22.

The send to print 32 causes the MFP 18 to print a print family document 26 or a non-print family document 28. The document printed may be received by the MFP 18 over the network and printed immediately by the MFP. Alternatively, the MFP 18 may print a document stored in the box 22 in response to a user request. If the document is a print family document 26, then it can be printed with any finishing parameters that may be included with the document. On the other hand, if the document is a non-print family document 28, then finishing parameters applied to the printed document can be determined automatically or a list of available finishing parameters can be presented to a user for selection. The determination of available finishing parameters will be described in greater detail herein.

The send to file 34 causes the MFP to store a document received over the network in the box 22. The send to e-mail 36 causes a document stored in the box 22 to be sent as an attachment to an e-mail. In particular, a user on a PC 12 may request an e-mail including as an attachment a document stored in the box 22. In response to the request, the applicable document is provided by the MFP 16 to the PC 12 or directly to the mail server 14.

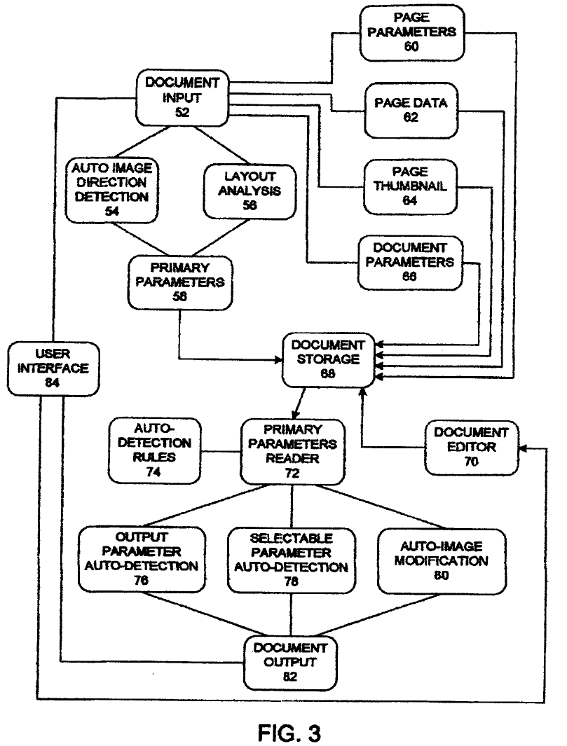

FIG. 3 is a block diagram of a finishing parameter detection system consistent with the present invention. The system can be implemented as a program stored on a hard disk drive, a programmed processor, or other know circuits. As shown in FIG. 3, the finishing parameter detection system includes document input 52, auto image direction detection 54, layout analysis 56, primary parameters 58, page parameters 60, page data 62, page thumbnail 64, document parameters 66, and document storage 68. The finishing parameter detection system also includes document editor 70, primary parameters reader 72, auto-detection rules 74, output parameter auto-detection 76, selectable parameter auto-detection 78, auto-image modification 80, document output 82, and user interface 84. These components of the finishing parameter detection system can all be implemented, for example, on the MFP 18. Alternatively, the components can be distributed among various devices coupled to the network.

The document input 52 corresponds to the reception of print family documents 26 and non-print family documents 28. Such documents can be received from any of the devices coupled to the network and include faxes from the fax 16, scanned documents from the scanner 20, e-mails from the mail server 14 and the PCs 12, documents copied by a copier or the MFP 18, and word processing or other types of documents requested to be printed at a printer or the MFP 18.

The auto image direction detection 54 determines the orientation of the image or data for each page of a document. The orientation information includes an indication of what constitutes the top of each page. The orientation information can also include an indication that the images on a page have an N:1 format, i.e., that there are N (N being an integer greater than one) complete page images on the page instead of one image per page.

The layout analysis 56 locates each object on a page of the document and determines the object type. Object types include, for example, text objects, graphical objects, and image objects. The information provided by the layout analysis thus identifies the position and type of each object. The information output from the auto image direction detection 54 and the layout analysis 56 is combined to form the primary parameters 58. In other words, the primary parameters 58 for a document include information identifying the top of each page, if the page has an N:1 format, the position of each object on the page, and the object type.

The page parameters 60 include, for example, paper type, paper size, compression format, page number, image data size, type of job (e.g., copy, print, scan or fax), image resolution, orientation, and number of image pixels (e.g., height and width). The page data 62 corresponds to the actual data of the document, such as image or text data. The page thumbnail 64 is a miniaturized representation or thumbnail image of the each page of the document. The document parameters 66 include, for example, simplex or duplex printing, number to be printed, paper source, destination, and other settings that control the manner in which the document can be printed including the finishing parameters, if any.

The documents are stored in the document storage 68, which can be the box 22 of the MFP 18 or other type of non-volatile storage medium coupled to the network. More particularly, the document storage 68 stores all of the information related to each document including the primary parameters 58, the page parameters 60, the page data 62, the page thumbnail 64, and the document parameters 68.

The document editor 70 can correspond to the editor 24 described above. In particular, the document editor 70 is configured to enable a user to view, edit, change, and save files and documents stored in the document storage 68. The editing functions include merging pages of two or more documents, cutting and copying of pages, and deleting pages.

The primary parameters reader 72 reads out the primary parameters 58 of a document that is to be printed. The primary parameters 58 read out by the primary parameters reader 72 are provided to the auto-detection rules 74. The auto-detection rules 74 apply rules to the primary parameters 58 to determine which finishing parameters can be applied to the document. In other words, based on application of the output of the auto image direction detection 54 and the layout analysis 56, which includes information identifying the top of each page, if the page has an N:1 format, the position of each object on the page, and the object type, to the rules in the auto-detection rule 74, all available finishing parameters can be determined for a document. The ability to determine the available finishing parameters applies not only to the print family documents 26, which may or may not have finishing parameters set in the document parameters 66, but also to non-print family documents 28. As a result, it is possible for finishing parameters to be set for a non-print family document 28 without a user manually setting them.

The finishing parameters determined to be available are provided to the output parameter auto-detection 76, the selectable parameter auto-detection 78, and the auto-image modification 80. The output parameter auto-detection 76 automatically selects which finishing parameters to apply to the document from the available finishing parameters. If there is more than one finishing parameter available, the output parameter auto-detection 76 can determine which finishing parameter or parameters to apply in accordance with a priority assigned to each finishing parameter. For example, if the available finishing parameters are staple and hole punch, then staple would be selected if it has an assigned priority higher than that for hole punch. Further, if the available finishing parameters are not in conflict (as, for example, staple and hole punch may be), then more than one finishing parameter may be selected, such as hole punch and image shift. The priority scheme may be pre-programmed.

The selectable parameter auto-detection 78, instead of automatically selecting the finishing parameters to apply to the document, displays the available finishing parameters to the user. The display may be shown, for example, on a display on the MFP 18. Alternatively, if a user at PC 12 requests printing of a document stored in the box 22, the display of the available finishing parameters may be shown on the PC 12. In response to the display of the available finishing parameters, the user selects which finishing parameters to apply.

The auto-image modification 80 enables images in a document to be moved or shifted to accommodate any finishing parameters. In particular, the auto-image modification 80 references the results of the layout analysis in the primary parameters 58 and the finishing parameters to be applied to the document and determines if an image shift is needed. For example, if the finishing parameter is a three-hole punch and, based on the result of the layout analysis, there is an object positioned where a hole is to be punched, then the auto-image modification 80 will shift the object or the whole image on the page so that the object is outside of the region being punched. The user may also be informed, for approval, of the image shift.

The finishing parameters, any image shift, the document image and any other printing parameters are provided to the document output 82. The document output 82 can be implemented, for example, as the printing unit of the MFP 18 or as a printer. The document output 82 reproduces the document in accordance with the finishing parameters, any image shift, the document image and any other printing parameters.

The user interface 84 is configured to enable a user to request a document be printed, to provide any other inputs with respect to how the document should be printed, including the selection of any available finishing parameters, and to enable the use of the document editor 70 to edit a document. The user interface 84 may be implemented, for example, as a display and touch panel or keyboard on the MFP 18. Alternatively, the user interface 84 can be implemented through the PC 12 so that a user can make document print requests or edit documents from the PC 12.

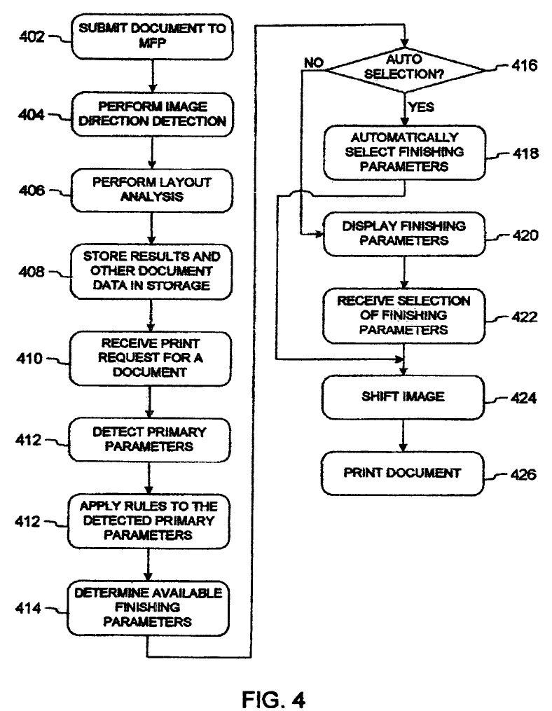

FIG. 4 is a flow diagram of a process for detecting available finishing parameters of a document consistent with the present invention. As shown in FIG. 4, a document is submitted to the MFP 18 (step 402). The document being submitted may be, for example, a document from a PC 12, such as a word processing document, a document being copied by the copying unit of the MFP 18, a fax from the fax 16, a scanned document from the scanner 20, or an e-mail from the mail server 14 or PCs 12. Further, the document may be a print family document 26 or a non-print family document 28. If the document is a print family document, then it may, or may not, already have designated finishing parameters.

An image direction detection analysis is performed on the document (step 404). The image direction detection analysis can be performed by the auto image direction detection 54. As described above, the image direction detection analysis is capable of determining the top or direction of each page of the document, as well as whether a page has an N:1 up configuration. In addition, a layout analysis is performed on the document (step 406). The layout analysis can be performed by the layout analysis 56. The layout analysis determines the position or location of each object on each page of the document, as well as each object type.

The results of the image direction analysis and the layout analysis, along with other document data, are stored in a storage unit coupled to the network (step 408). The other document data includes, for example, the page parameters 60, the page data 62, the page thumbnail 64, and the document parameters 66. As described above, the combination of the results of the image direction analysis and the layout analysis constitute the primary parameters 58. All of this data can be stored in the document storage 58, which may be the box 22 of the MFP 18 or other storage unit coupled to the network.

With the document and the relevant data stored in the storage unit, a request is received to print the document (step 410). The document requested to be printed can be one just submitted to the MFP 18 or one already stored in the box 22 of the MFP 18 or other storage unit. In response to the print request, the primary parameters for the document are detected (step 412). The primary parameters include the results of the image direction detection analysis performed by the auto image direction detection 54 and the results of the layout analysis performed by the layout analysis 56. These results include determining the top or direction of each page of the document, whether a page has an N:1 up configuration, the position or location of each object on each page of the document, and each object type. To detect the primary parameters, the primary parameters reader 72 can read them out from the document storage 68.

The primary parameters read from the document storage are applied against a group of rules in the auto-detection rules 74 (step 414). Based on the application of the rules to the primary parameters, it is possible to determine which finishing parameters are available to print the document (step 416). To make this determination, the rules are configured to determine, based on the primary parameters for each page of the document, which types of finishing parameters would be acceptable to each page of the document.

For example, if a non-print family document 28 has some pages that are 2:1 up and some pages with just one up-image per page, a hole punch on one side in the middle may be permissible, but a staple in an upper corner may not. Further, if a print family document 26 having an upper corner staple setting in its corresponding document parameters 66 is merged with a non-print family document 28 having 2:1 up pages, the staple setting from the print family document 26 may be impermissible due to the 2:1 up pages of the non-print family document 28.

More particularly, if a first document has two pages, each page having a top orientation (i.e., top of image oriented to top of page) and a 1:1 up image arrangement, then the permissible finishing parameters would be determined to include a staple in the top left or center left position of the page and a hole punch in the center left position of the page. If a second document also has two pages, but each page has a left orientation (i.e., top of image oriented to left of page) and a 2:1 up image arrangement, then the permissible finishing parameters would include a staple in the center left, bottom left, or saddle stitch (i.e., across the middle of the page between the two images of the 2:1 up image arrangement) position of the page or a hole punch in the center left position of the page. For the first document, the bottom left and saddle stitch staple positions are not available, and the top left staple position is not available for the second document. If the first and second documents are merged, then the permissible finishing parameters for the merged document would be the center left staple position and the center left hold punch. Accordingly, when the documents are merged, the available finishing parameters correspond to the finishing parameters that are available in both the first document and the second document.

Having determined the available finishing parameters, the process checks whether to select the finishing parameters automatically (step 416). This determination can be made from a setting of the MFP 18. For example, the MFP 18 can have a finishing parameters setting that is set so that the finishing parameters are selected automatically or is set so that a user selects from available finishing parameters. The finishing parameters setting may have a default setting or may be set by a user through the user interface 84 before submitting a print request for the document.

If the answer is YES, then the finishing parameters are selected automatically from the available finishing parameters (step 418). The automatic selection of finishing parameters can be performed by the output parameter auto-detection 76. As described above, if there is more than one finishing parameter available, the output parameter auto-detection 76 can determine which finishing parameter or parameters to apply in accordance with a priority assigned to each finishing parameter. In addition, if the available finishing parameters are not in conflict (as, for example, staple and hole punch may be), then more than one finishing parameter may be selected, such as hole punch and image shift.

On the other hand, if the answer is NO, then the available finishing parameters are displayed to the user (step 420). In particular, under the control of the selectable parameter auto-detection 78, the available finishing parameters may be shown on a display on the MFP 18 or on the user's PC 12. In response to the display of the available finishing parameters, the user selects which finishing parameters to apply, and the selection is received by the MFP 18 (step 422).

Before proceeding to print the document based on the selected finishing parameters, an image shift may be performed (step 424). The image shift can be performed by the auto-image modification 80. The auto-image modification 80 performs an image shifting process to determine whether or not an image shift is to be performed.

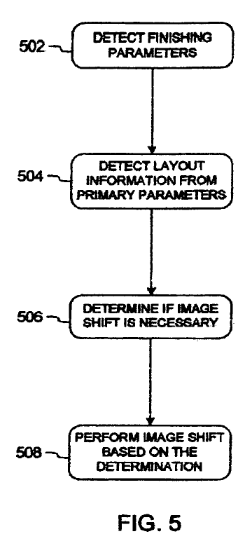

FIG. 5 is a flow diagram of an image shifting process consistent with the present invention. As shown in FIG. 5, the image shifting process first detects the finishing parameters to be applied to the document (step 502). The finishing parameters may include an image shift, in which case the image shift is performed, as will be described in more detail herein. However, assuming the finishing parameters do not include an image shift, the auto-image modification 80 also detects the layout information for the document from the primary parameters 58 (step 504).

Based on the detected finishing parameters and the detected layout information, the auto-image modification 80 determines if an image shift is necessary (step 506). An image shift may be necessary if the detected finishing parameters would interfere with an object identified in the layout information from the primary parameters 58. For example, if an object is positioned where a hole is to be punched or a staple is to be placed, then the auto-image modification 80 will shift the object or the whole image on the page so that the object is outside of the region where the hole punch or staple is to be placed. Further, before making the image shift, the user may first be given an option to approve the image shift.

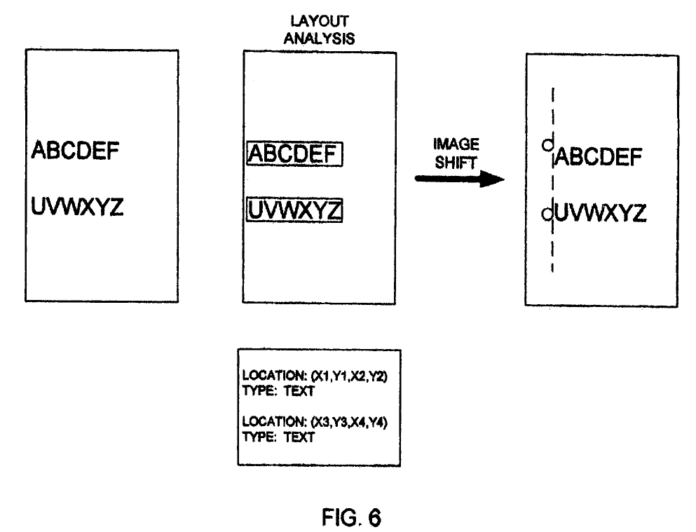

To further explain the image shifting process, reference is made to FIG. 6, which is a graphical representation of an image shift consistent with the present invention. As shown on the left side of FIG. 6, a page of the document includes two different text areas that are positioned on the left edge of the page. The layout analysis 56 identifies the two different text areas as two objects, determines their locations, and determines each object type. The results of the layout analysis are shown with the coordinates of each object and an indication that each object type is text. In this case, the finishing parameters indicate that two hole punches are to be made on the left side of the page. Based on the location information of the text objects and the two-hole punch, the auto-image modification 80 determines that the hole punches would interfere with both text objects. As a result, as shown on the right side of FIG. 6, the two text objects are shifted to the right to accommodate the hole punches.

Returning to FIG. 4, based on the document image, the finishing parameters, any image shift, and any other printing parameters (e.g., page size, double sided, etc.) the document is printed (step 426). The printing can be performed by the document output 82, which can be implemented, for example, as the printing unit of the MFP 18 or as a printer separate from the MFP 18.

In accordance with the present invention, it is possible for a document to be printed with finishing parameters without a user designated what finishing parameters to use. This automatic designation is possible for both print family documents 26 and non-print family documents 28. Furthermore, even when non-print family documents 28 are stored in the box 22 of the MFP 18, it is possible for a user to edit the document or merge two or more documents.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiments (which can be practiced separately or in combination) were chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for determining finishing parameters for a document having one or more pages, comprising:
performing an image direction detection analysis that determines an image direction for each page of the document;
performing a layout analysis that determines a location and type of at least one object for each page of the document;
applying at least one rule to results of the image direction detection analysis and the layout analysis; and
determining at least one available finishing parameter for the document based on applying the at least one rule to the results of the image direction detection analysis and the layout analysis.

2. A method according to claim 1, further comprising:
selecting at least one finishing parameter from the finishing parameters determined to be available.

3. A method according to claim 2, wherein the finishing parameters are selected automatically.

4. A method according to claim 3, wherein a priority is set for each finishing parameter, and the finishing parameters are selected in accordance with the set priority.

5. A method according to claim 4, wherein the finishing parameters are selected in accordance with the set priority if the document is a non-print family document or if the document is a print family document having no preset finishing parameters.

6. A method according to claim 2, further comprising:
displaying each of the finishing parameters determined to be available; and
selecting the finishing parameters in response to a user input.

7. A method according to claim 1, further comprising:
determining one or more page parameters for the document, the page parameters relating to characteristics of each page of the document; and
determining one or more document parameters for the document, the document parameters relating to settings for reproducing the document.

8. A method according to claim 7, further comprising:
storing, in a storage area, the determined page parameters, the determined document parameters, and the determination results of the image direction detection analysis and the layout analysis as collective document data;
storing image information of the document in the storage area; and
linking the image information of the document with the collective document data.

9. A method according to claim 1, further comprising:
scanning the document with a scanner,
wherein the image direction detection analysis and the layout analysis are performed on each page of the scanned document.

10. A method according to claim 1, further comprising:
receiving the document as a fax,
wherein the image direction detection analysis and the layout analysis are performed on each page of the received fax document.

11. A method according to claim 1, further comprising:
storing a plurality of documents in a storage area of a multi-function printer.

12. A method according to claim 11, further comprising:
receiving an indication from a user to edit at least one of the plurality of documents in the storage area;
providing the at least one of the plurality of the documents to the user based on the indication;
initiating an editing application that enables the user to edit the at least one of the plurality of the documents.

13. A method according to claim 12, wherein the at least one of the plurality of the documents includes two documents, the method further comprising:
merging the two documents into a single merged document based on a merge request from the editing application.

14. A method according to claim 13, further comprising:
performing the image direction detection analysis that determines an image direction for each page of the merged document;
performing the layout analysis that determines a location and type of at least one object for each page of the merged document;
applying at least one rule to results of the image direction detection analysis and the layout analysis; and
determining at least one available finishing parameter for the merged document based on applying the at least one rule to the results of the image direction detection analysis and the layout analysis.

15. A method according to claim 14, wherein at least one finishing parameter is associated with one of the two documents merged together to form the merged document, and
wherein at least one of at least one associated finishing parameter is determined not to be among the at least one available finishing parameter for the merged document.

16. A method according to claim 1, further comprising:
determining if a finishing parameter is interfered with by an object on a page of the document based on the layout analysis; and
performing an image shift to the page of the document so that the object on the page does not interfere with a finishing parameter.

17. A method according to claim 1, wherein the at least one available finishing parameter includes at least one of a staple, a hole punch, and an image shift.

18. A method for determining finishing parameters for a document having one or more pages, comprising:
performing a layout analysis that determines a location and type of at least one object for each page of the document;
applying at least one rule to results of the layout analysis; and
determining at least one available finishing parameter for the document based on applying the at least one rule to the results of the layout analysis.

19. An apparatus for determining finishing parameters for a document having one or more pages, comprising:
an image direction detection analysis unit that determines an image direction for each page of the document;
a layout analysis unit that determines a location and type of at least one object for each page of the document; and
a finishing parameter determination unit that applies at least one rule to the determinations of the image direction detection analysis and the layout analysis and determines at least one available finishing parameter for the document based on applying the at least one rule to the determinations of the image direction detection analysis unit and the layout analysis unit.

20. An apparatus for determining finishing parameters for a document having one or more pages, comprising:
a layout analysis unit that determines a location and type of at least one object for each page of the document; and
a finishing parameter determination unit that applies at least one rule to the determination of the layout analysis and determines at least one available finishing parameter for the document based on applying the at least one rule to the determination of the layout analysis unit.
